(19) United States
(12) Patent Application Publication
(10) Pub. No.: US 2015/0216332 A1
(43) Pub. Date: Aug. 6, 2015

(54) WOVEN MATTRESS FOOT PROTECTOR AND PILLOW SHAM/BOLSTER WITH BRANDING AND METHOD OF USE

(71) Applicant: Gordon Steve CLAY, Knoxville, TN (US)

(72) Inventor: Gordon Steve CLAY, Knoxville, TN (US)

(21) Appl. No.: 14/685,810

(22) Filed: Apr. 14, 2015

Related U.S. Application Data
(63) Continuation of application No. 13/759,507, filed on Feb. 5, 2013, now abandoned.
(60) Provisional application No. 61/661,437, filed on Jun. 19, 2012.
(60) Provisional application No. 61/605,887, filed on Mar. 2, 2012.

(51) Int. Cl. A47G 9/00; A47G 9/02; D03D 1/00; A47C 19/02; G09F 23/00; A47G 9/10; A47C 31/10

(52) U.S. Cl. CPC A47G 9/00; A47G 9/10; A47G 9/0253; A47G 9/0238; A47C 31/105; A47C 19/022; G09F 23/00; D03D 1/0017

(57) ABSTRACT

A mattress protector comprising one or more of a foot protector, pillow sham, or bolster pillow or a headboard cover is made of a woven upholstery fabric, the woven upholstery fabric including a trademark woven therein. The foot protector, pillow sham, bolster pillow, and/or the headboard cover can be used in a retail environment or room containing a mattress to promote a company, such as a mattress manufacturer or lodging provider. The mattress protector and/or headboard cover can be used to promote the mattress manufacturer or other entity seeking to improve its name brand recognition. The fabric used to make the protector or headboard cover is made using a jacquard loom.

This application claims priority under 35 USC 119(e) based on provisional application No. 61/605,887, filed on Mar. 2, 2012, and provisional application No. 61/661,437, filed on Jun. 19, 2012. These provisional applications are hereby incorporated by reference herein in their entirety.

### FIELD OF INVENTION

The present invention relates a foot protectors, pillow shams/bolsters, and headboard covers for mattresses, and particularly to foot protectors, pillow shams/bolsters, and headboard covers that are made of woven upholstery fabric, with the upholstery fabric including a branding or trademark woven therein.

### BACKGROUND ART

A foot protector and pillow sham/bolster pillow are used as a marketing tool and also as a way of protecting a mattress in a retail selling environment. The foot protector is used as the central branding point for marketing a mattress and couples as protection from soiling of the floor room sample. The pillow sham/bolster pillow is also a way to market the brand, while protecting the mattress from soiling. Both the foot protector and pillow sham/bolster are important in marketing the brand to the consumer.

More particularly, a foot protector is a manufactured item that is placed at the foot of a mattress on the showroom floor. It is made to span the width of the mattress and exemplary sizes include from 13″ to 22″ in width and approximately 80″ or more inches in length so that it extends transversely at least across the top of the mattress for protection of the mattress from soiling. It is typically made from a fabric such as velvet or ultrasuede or vinyl or plastic, and patterns and construction may vary. The foot protector has a certain length that enables. The length can vary depending on whether the foot protector is designed to cover the sides of the mattress or even extend under the mattress. The width of the foot protector (measured along the long dimension of the bed) is designed to extend along the longitudinal length of the mattress to an extent that would provide protection for the mattress against soiling by the shoes of a person that is lying on the bed to test its comfort. The protector can be held in place by any means, including some type of fastening means on the free ends of the protector, hook and loop fasteners, ties, clips, etc., or just tucking free ends of the protector underneath the mattress. Further yet, the foot protector could be just laid over the top of the mattress or be cut so that end portions drape over the sides of the mattress.

Typical prior art foot protectors are shown in the photographs of FIGS. 1a and 1b. The foot protectors are designated by the reference numeral 10 and 20 respectively. Each have ends 11 and 21 respectively and a trademark 13 and 23 associated therewith. The foot protector 10 has the trademark 13 embroidered onto the fabric and the foot protector 20 has the trademark 23 printed thereon. The foot protector 10 has a border 15, which is a separate fabric that is sewn onto the fabric forming the foot protector.

A pillow sham/bolster is a manufactured item that is placed at the head of a mattress on the showroom floor for example. One long bolster or several smaller pillow shams may be used to span the entire width of the mattress. They are also typically composed of velvet or ultrasuede, with patterns, construction and finished sizes varying. Since the construction of these are well known, a further description is not needed for understanding of the invention.

Again, the purpose of the foot protector and pillow sham/bolster is twofold. Firstly, there is a practical purpose—to protect a mattress from becoming soiled on the showroom floor. Secondly, these items have evolved into prime branding opportunities for manufacturers and retailers, giving them the perfect platform to identify the mattress brand and make an initial impression upon the consumer.

As noted above, the prior art foot protectors and pillow shams/bolsters are typically made by first selecting a fabric or other non-woven substrate such as ultrasuede, vinyl or plastic. Then, the brand and other marketing information are added through the method of embroidery or printing. These methods are well known throughout the mattress industry worldwide.

Due to a limited number of companies selling this product to mattress manufacturers, there are few opportunities for the mattress manufacturers to stand out from their contemporaries. Upon entering a mattress retail environment, a consumer, sees a lot of the same thing—a first foot protector and pillow sham/bolster on a mattress advertising a first brand on the protector with a second foot protector and pillow sham/bolster showing a second and different brand using the exact same material and style of branding as used in the first foot protector. Therefore, there is no significant branding opportunity for the mattress manufacturer to make their product stand out as compared to their competition.

The manner in which a manufacturer or other company's brand or trademark is displayed is also problematic. Embroidery is limited in its scope because of the limitations in size of the application of the applied brand and information. The cost is also prohibitive when there are multiple embroidered areas. Embroidery applied to light weight fabrics also changes the consistency of how the fabric will lay and can cause gathering, which detracts from the brand.

Another method used in the prior art to show a brand on a foot protector or pillow sham/bolster is die sublimation printing onto fabric and other nonwoven substrates. This is a fairly new process that is being used for foot protectors and pillow sham/bolster. It has its place in marketing and branding mattresses on the retail floor. It is a billboard way of branding but still does not provide an aesthetic or refined look when used on fabric.

The present invention overcomes the deficiencies in the prior art by providing foot protectors and pillow shams/bolsters that offer more elaborate and attractive looks in terms of fabric, fabric patterns, and trademark display.

### SUMMARY OF THE INVENTION

The invention provides a much improved way to market mattresses over the conventional ways of using printed or embroidered fabrics for items such as mattress foot protectors, pillow shams, bolster pillows and headboard covers. In one aspect of the invention, a mattress protector is provided that comprises one or more of a foot protector, pillow sham, or bolster pillow with the mattress protector made of a woven upholstery fabric, the woven upholstery fabric including a trademark woven therein, wherein the fabric including the trademark is woven using a jacquard loom.

The invention also entails a headboard cover that is made of the same fabric and including the same features of the mattress protector comprising one of more of the foot protector, the pillow sham, and the bolster pillow.

While the mattress protector or headboard cover can display any number of different trademark, it is preferred that the trademark is associated with a mattress manufacturer or a service industry such as the spa industry, resort industries, and hotel industry.

In a preferred embodiment, the fabric employed with the mattress protector or headboard cover has a fill yarn denier range of 100-5000 and/or a warp yarn denier range of 100-600.

The invention also entails a method of displaying a mattress in a retail environment or a bedroom using at least one or more of a foot protector, a pillow sham, a bolster pillow on the mattress or a headboard cover. The inventive method uses the unique foot protector, the pillow sham, and/or bolster pillow, and/or the headboard cover in combination with the mattress. Preferably, at least the foot protector is used on the mattress and more preferably, the display method is done in a retail store selling mattresses.

The invention further entails a method of making a mattress protector comprising at least one or more of a foot protector, a pillow sham or bolster pillow, or making a headboard cover, wherein the mattress protector or headboard cover is made from a upholstery fabric using a jacquard loom. The making step including weaving a trademark into the upholstery fabric, the trademark displayed on the mattress protector or headboard cover to promote a brand in connection with the trademark's display.

The invention also entails the combination of a mattress and a mattress protector comprising one or more of a mattress foot protector, a pillow sham, and a bolster pillow or the combination of a mattress and headboard, wherein the mattress protector and the headboard are each made of a woven upholstery fabric, the woven upholstery fabric including a trademark woven therein, wherein the fabric including the trademark is woven using a jacquard loom. A preferred combination is at least the mattress and mattress foot protector.

### BRIEF DESCRIPTION OF THE DRAWINGS

FIG. 1a shows a top view of a prior art mattress foot protector with a printed trademark thereon.

FIG. 1b shows a top view of a prior art mattress foot protector with an embroidered trademark thereon.

FIG. 2a shows a top view of one example of an inventive foot protector.

FIG. 2b shows a top view of another example of an inventive foot protector.

FIG. 3a shows a top view of yet another example of an inventive foot protector.

FIG. 3b shows a top view of a further example of an inventive foot protector.

FIG. 4 shows a perspective view of an inventive pillow sham on a pillow.

FIG. 5 shows a perspective view of an inventive headboard.

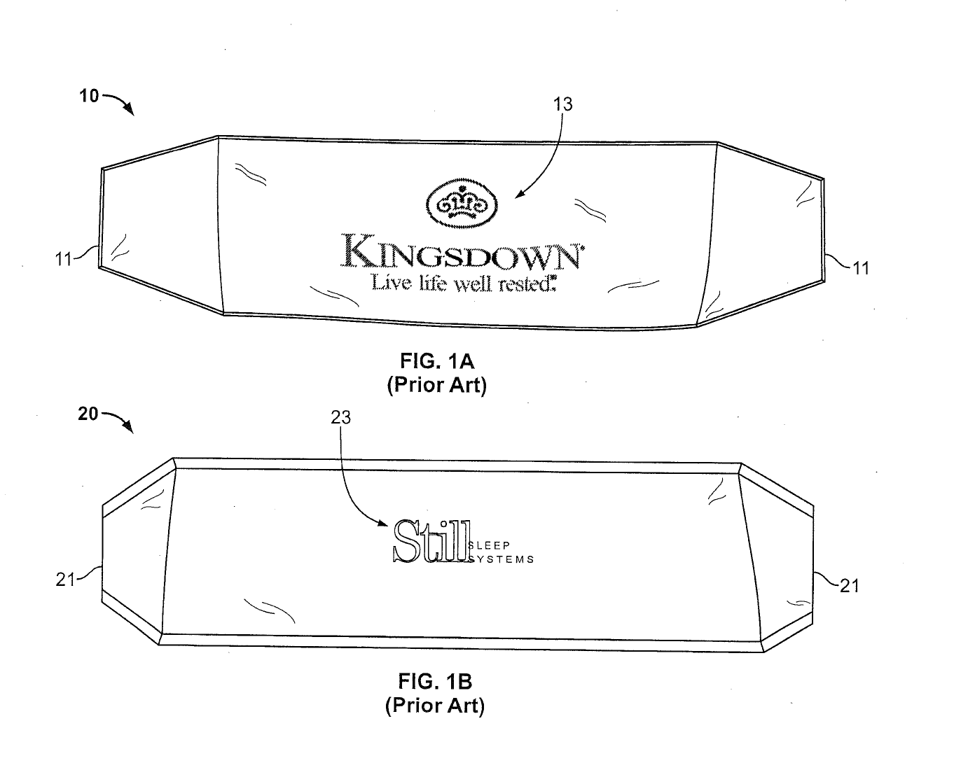

### DESCRIPTION OF THE INVENTION

The invention relates to mattress foot protectors, pillow shams or bolster pillows, and headboard covers. Hereinafter, recitation of a mattress protector is intended not only to encompass foot protectors but also pillow shams and bolster pillows or any other article of manufacture that would be used to market a bed or mattress, including a headboard cover.

The mattress protector of the invention is a completely woven product that includes a trademark woven therein. A trademark can be a name, a logo or design, or combination thereof for a particular entity, e.g., a company, organization, or individual(s) and the like.

The fabric used in the mattress protector is an upholstery fabric, which is heavy duty fabric. While upholstery fabric is a term of art in the fabric industry, it has a number of characteristic that distinguish it from other fabrics. The characteristics include the type of yarn, the denier of the yarn, weight of the yarn per unit area, manufacturing variables such a pick count and the like. While it is believed that using “upholstery” to define the type of fabric identifies the material to be used in the invention, examples of the characteristics of upholstery fabrics can include warp yarn having a denier range of 100-600, fill yarns having a denier range of 100-5000. Certain yarns such as chenille, boucle, and novelty yarns, while still fill yarns, are not normally characterized or gauged by denier. Instead, they are gauged in terms of yards per pound (YPP), with a range of 500-3000 YPP. Cotton count yarns as fill yarns would have a YPP range of 3-60. A typical pick count for the upholstery fabric used for the foot protector is in the range of 40-150 picks per inch, with a more preferred range of 80-100 picks per inch. Other characteristics of upholstery fabric are that it is durable and stiff so that it will hold up to wear and tear when used on furniture for example.

Upholstery fabric is distinguished from fabric used in the prior art such as ultrasuede and plastic materials because some ultrasuede is not a woven product and plastics are not considered to be a fabric. While velvet can be considered a woven fabric, the prior art foot protectors normally adding a separate layer of material to display a particular trademark. Also, velvet is relatively expensive to make so that it is not as popular for use with foot protectors; ultrasuedes or microsuedes have replaced velvet in popularity due to the fact that they are much less expensive. Further yet, velvet is made using a special loom, which is not required when making the mattress protectors of the invention.

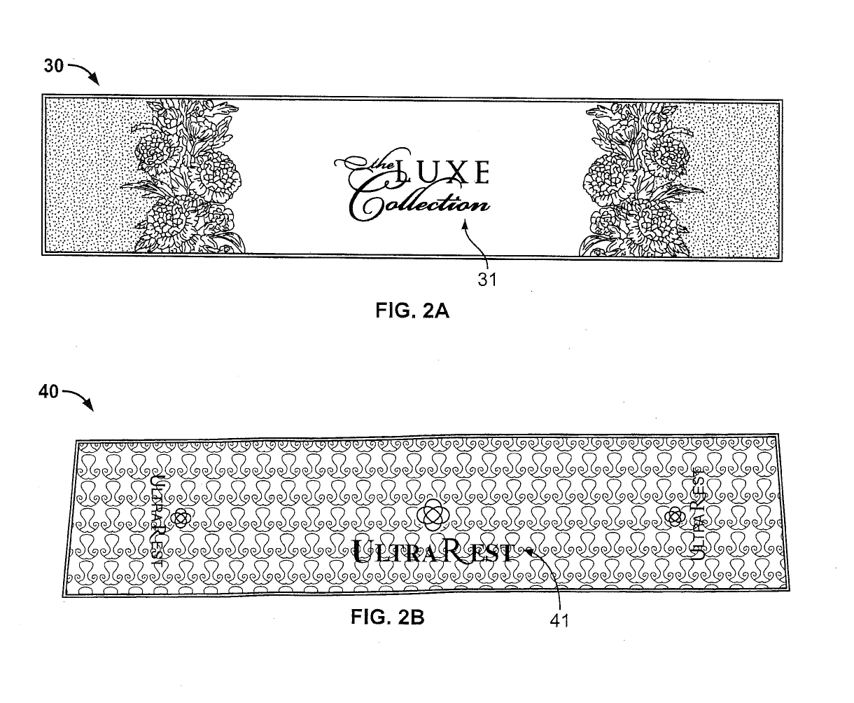

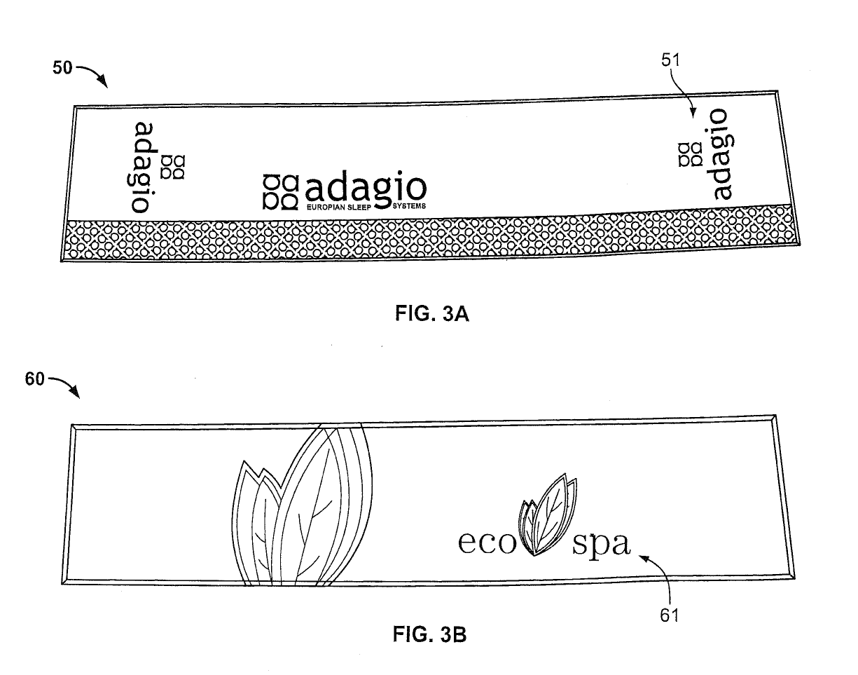

FIGS. 2a and 2b show photographs of two different foot protectors 30 and 40. Each shows an elaborate pattern, a repeating one in protector 30 and a floral pattern in protector 40. Each protector has a trademark, mark 31 in protector 30 and mark 41 in protector 40. FIGS. 3a and 3b show two more protectors 50 and 60, each with their own distinct pattern and trademarks 51 and 61. As can be seen from the protectors 30-60, the possibilities of patterns, colors, orientations of trademarks are endless.

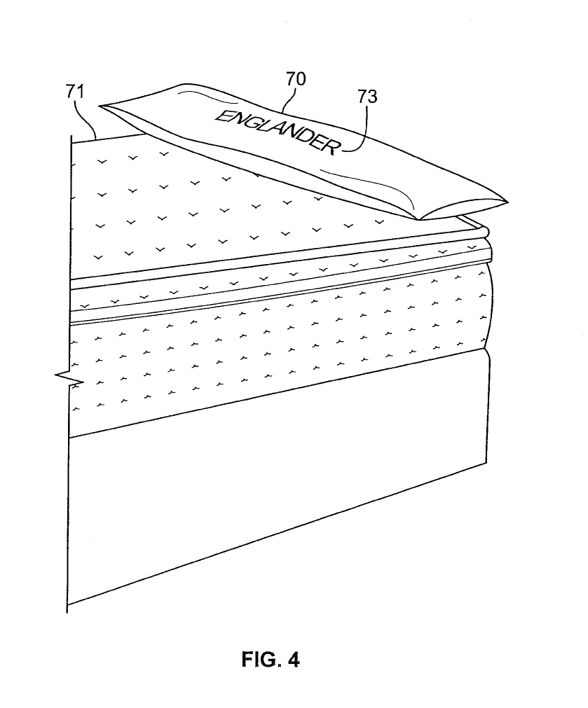

FIG. 4 shows a pillow sham 70 and a bed 71. The sham 70 has a trademark 71 woven into the fabric. Since the construction of bolster pillows are well known, e.g., a typical one is found at http://www.potterybarn.com/products/cameron-organic-matelasse-bolster-pillow-cover/; they are made in a more cylindrical construction, it is not necessary to illustrate one with the upholstery fabric and woven trademark of the invention for understanding of the invention.

A preferred method of making the foot protector of the invention is as follows:

First, a design is selected, preferably using graphic designer, who is knowledgeable in both graphic design and textile weaving capabilities. Once the graphic design is finalized, it incorporates all of the required branding information, yarn selection, and design pattern, if one, is used.

The design is then provided to a textile designer. The textile designer will then translate the graphic design into a woven product. In the textile design process, warp yarns must be selected, as well as fill yarns. The fill yarns being the more important selection, because it is these yarns that are the most visible on the finished woven product. The product is woven on a jacquard loom using yarns that are used in the upholstery fabric industry. Jacquard looms for making upholstery fabric are well known in the fabric industry so that a description is not required for understanding of the invention. As noted above, the upholstery industry uses chenille, taslan, boucle, filament, novelty, and flat yarns, for example, for fill yarns that are heavy in nature. The warp yarns tend to be a lighter denier. Colors of yarns consistently change due to industry trends in the furniture industry.

Once the fabric is woven, it can then undergo any number of finishing processes that are known in the art. The first is a needle punching to tie the yarns together which promotes bonding. This process also lifts the yarns to make a plush and soft hand.

The second finishing process is to add a latex binding to the back side of the fabric. This strengthens the fabric and greatly reduces shifting of the yarns. Upon completion, the fabric is then inspected for defects and then put on rolls and packaged, e.g., polybag wrapped, for shipment.

The next step in the process to complete the manufacturing of the foot protector and pillow sham/bolster is to cut and sew the fabric into the appropriate size. Since the actual manufacture of the foot protector are well known in the prior art, a further description of this step is not necessary for understanding of the invention. There is nothing unique or different about the process of actually making a foot protector, pillow sham, bolster pillow in relation to what is currently being done.

It is preferred to use a jacquard loom to make the inventive mattress protector because this type of loom provides the ability for the intricate weaving that is needed to include the trademark as part of the woven material. Put another way, the pick count or number of fill yarns is relatively high when making the elaborate patterns and logos and jacquard loom weaving is ideal for these applications.

The advantages of the invention, utilizing a completely woven branded foot protector and pillow sham/bolster, are numerous. Embroidery is limited in its scope because you are limited in size of the application of the applied brand and information. The cost is also prohibitive when there are multiple embroidered areas. Embroidery applied to light weight fabrics also change the consistency of how the fabric will lay and can cause gathering, which detracts from the brand.

When weaving the mattress protector, there is no limit to the size of the brand or the information woven therein. While embroidery does allow for a sharper image; the beauty of the woven image incorporated into a consistent fabric far outweighs the embroidery sharper image advantage.

The weight of the upholstery fabrics used provides another major advantage as compared to the fabrics used in the prior art foot protectors. A heavier weight fabric such as used in the upholstered fabric industry, woven with heavy denier yarns, will lay and drape much better than the lighter weight fabrics used in today's foot protectors and pillow sham/bolster. When embroidery is used in the construction process, it is very difficult to embroider onto heavy fabric. A dense and plush fabric, such as a chenille or a boucle, is too thick for embroidery to stand out over the surface of the fabric and it is also an extremely difficult embroidery process. Due to these inherent weaknesses utilizing embroidery, fabrics being used for embroidery are very flat surfaces with little or no dimension.

As compared to the fabric used in the prior art foot protectors, a woven product is completely different. The weight is very heavy in comparison, and the surfaces are very plush with a lot of dimension. The brand and text woven therein are not limited in any way. The opportunities are limitless when weaving as opposed to current methods used. The inventive foot protector allows for the use of the vibrant beauty of the yarns and their weight to provide a stunning presentation of a company's brand and product.
1. The mattress protector is a completely woven product. Rather than choosing from a selection of base fabrics, the customer has the opportunity to create their own fabric for their product.
2. With the logos and graphics incorporated into the weave design, there is no need for further embroidery or printing. There is no restriction when is comes to logo size.
3. Each product is specifically designed for each customer and is therefore completely customizable.

A prime user of foot protectors, pillows, bolsters, and/or headboard covers would be mattress manufacturers that would use the products in connection with their mattress products on display in retail stores. Other users could be service industries that use mattresses, e.g., the hotel industry, spas, resorts, etc. For example, Marriott® could use the foot protectors in their hotel rooms, thus emphasizing their trademark.

Mattress manufacturers also include headboard covers as a means to market mattresses. Thus, the invention also encompasses the use of the woven upholstery fabric on a headboard cover for a bed.

Currently used headboards suffer from the same problems that foot protectors and the like do as mentioned above. That is, embroidered covers are limited in the size of the embroidery. There is also the problem of puckering and gathering when the embroidery stitching is applied that compromises the look of the headboard cover. Headboard covers that include printing have a billboard look that lacks dimension and texture.

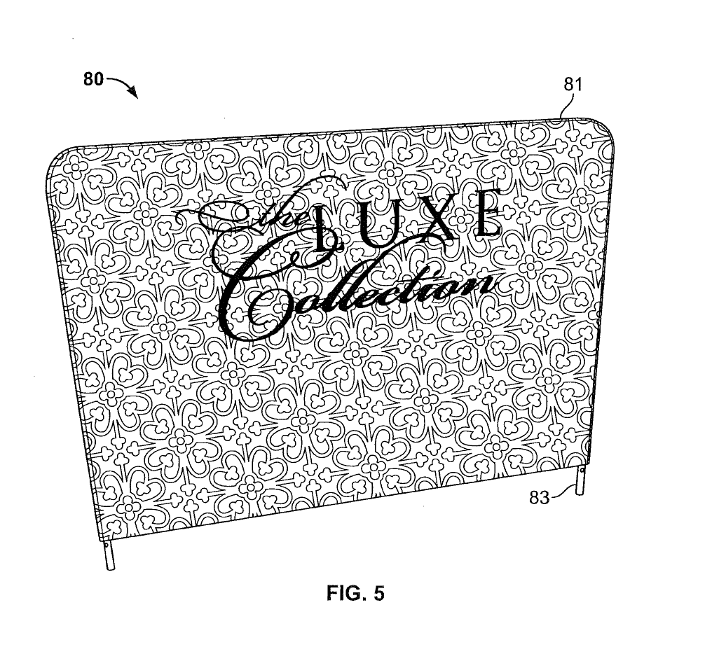

FIG. 5a shows a typical printed headboard cover 50 with a front 51 having the printing thereon. FIG. 5b shows the back 53 of the headboard cover 50 of FIG. 5a. FIG. 5c shows an embroidered headboard cover 60 with an embroidered logo 61 on its front 63, with FIG. 5d showing its back 65. FIG. 5e shows a typical headboard frame 70 with top cross bar 71, legs 73, bottom bar 75, and cross members 77. The prior art headboard frame and covers are well known so that a further description of them is not needed for understanding of the invention.

In this embodiment, the woven upholstery fabric with the trademark woven therein is used to cover the structure of the headboard. Preferably, the trademark that is found on the foot protector, pillow, and/or bolster would match the trademark shown on the headboard. This offers an even better branding for the manufacturer of the mattress.

One example of a headboard construction is the use of a metal frame that would either be free standing or mountable to the bed frame. The headboard cover is constructed with a front and back fabric panel that is a woven upholstery fabric that includes the desired trademark. The fabric is sewn together to form a pocket with three sewn sides and an open bottom. The cover can then be slid over the headboard frame with the frame sliding into the open bottom. The inventive headboard is shown in FIG. 5 and designated by the reference numeral 80. The headboard includes a cover 81, which is made in the same way as the foot protector and other mattress-related products described above. That is, the fabric would be the same as that used for the foot protector and pillows/bolsters with the trademark thereon and being displayed on the headboard. The cover 81 is shown slid over a headboard frame, whose legs 83 are shown in FIG. 5. A further description of the headboard and its cover are not believed to be necessary for understanding of the invention.

As such, an invention has been disclosed in terms of preferred embodiments thereof which fulfills each and every one of the objects of the present invention as set forth above and provides a new and improved way to market mattresses using a unique construction for mattress-related products such a foot protectors, headboard, pillow shams, bolster pillows, and the like.

Of course, various changes, modifications and alterations from the teachings of the present invention may be contemplated by those skilled in the art without departing from the intended spirit and scope thereof. It is intended that the present invention only be limited by the terms of the appended claims.

1. A mattress protector comprising one or more of a foot protector, pillow sham, or bolster pillow, or a headboard cover, the mattress protector and headboard cover each made of a woven upholstery fabric, the woven upholstery fabric including a trademark woven therein, wherein the fabric including the trademark is woven using a jacquard loom.

2. The mattress protector or headboard cover of claim 1, wherein the trademark is associated with a mattress manufacturer.

3. The mattress protector or headboard cover of claim 1, wherein the trademark is associated with a service industry.

4. The mattress protector or headboard cover of claim 1, wherein the fabric has a fill yarn denier range of 100-5000 and/or a warp yarn denier range of 100-600.

5. The mattress protector or headboard cover of claim 3, wherein the service industry is one or more of a hotel industry, a spa industry, and a resort industry.

6. In a method of displaying a mattress in a retail environment or a bedroom using at least one or more of a foot protector, a pillow sham, a bolster pillow on the mattress or a headboard cover, the improvement comprising using the foot protector, the pillow sham, the bolster pillow, and/or the headboard cover of claim 1 in combination with the mattress.

7. The method of claim 6, wherein the foot protector is used on the mattress.

8. The method of claim 7, wherein the foot protector is displayed in a retail store selling mattresses.

9. In a method of making a mattress protector comprising at least one or more of a foot protector, a pillow sham or bolster pillow or making a headboard cover, wherein the mattress protector or headboard cover is made from a material, the improvement comprising making an upholstery fabric using a jacquard loom as the material for the mattress protector, the making step including weaving a trademark into the upholstery fabric, the trademark displayed on the mattress protector or headboard cover to promote a brand in connection with the trademark's display.

10. The combination of a mattress and a mattress protector comprising one or more of a mattress foot protector, a pillow sham, and a bolster pillow or the combination of a mattress and headboard, wherein the mattress protector and the headboard are each made of a woven upholstery fabric, the woven upholstery fabric including a trademark woven therein, wherein the fabric including the trademark is woven using a jacquard loom.

11. The combination of claim 10 further comprising the mattress and mattress foot protector.

12. The mattress protector or headboard cover of claim 1, comprising the headboard cover made of the woven upholstery fabric and trademark.

13. The mattress protector or headboard cover of claim 1, comprising the foot protector, the pillow sham, the headboard cover, and the bolster pillow.

14. The combination of claim 10, comprising the headboard cover.

15. The combination of claim 10, comprising the foot protector, the pillow sham, the headboard cover, and the bolster pillow.

16. The mattress protector or headboard cover of claim 1, comprising the foot protector.

17. The mattress protector or headboard cover of claim 16, wherein the foot protector has a pick count of 40-150 picks per inch.

18. The mattress protector or headboard cover of claim 16, wherein the foot protector has a pick count of 80-100 picks per inch.
